(19) United States
(12) Patent Application Publication
(10) Pub. No.: US 2003/0106062 A1
(43) Pub. Date: Jun. 5, 2003

(54) Home network environment as a state machine

(75) Inventors: Yevgeniy Eugene Shteyn, Cupertino, CA (US); Mark Baer Hoffberg, Palo Alto, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/011,702

(22) Filed: Dec. 5, 2001

(51) Int. Cl. H04N 7/18; H04N 7/16

(52) U.S. Cl. 725/78; 725/141; 725/153

(57) ABSTRACT

A home network is controlled as a super state machine consisting of a plurality of state machines of electronic consumer appliances attached to the home network. Setting the state of the home network results in setting the states of multiple appliances that are connected to the network. The system can automatically determine whether a particular network state would be reliable. For example, the system may present the user with a selection of reliable network states and the user can select a reliable network state that is meaningful to the user. The selected meaningful state may be stored or may be immediately implemented upon the user selection.

### FIELD OF THE INVENTION

The invention relates to home networks of consumer electronics devices and more specifically to controlling such a home network as a state machine.

### BACKGROUND OF THE INVENTION

Many home appliances (e.g. televisions, VCRs, lamps) operate as state machines. They change states in response to input from switches, sensors or timers. They are often operated by a user manipulating switches on the front of the appliance or on a remote control to switch the appliances from one state to another state (e.g. power-on, record, rewind, play, power-off). This approach to device control has proved to be convenient for device design, simple to operate, and easy for consumers to learn.

Some of the states may be rather complex, for example, for some types of VRCs, once set to record a program in some remote future period of time, the tape can not be ejected or repositioned (record, play, rewind, fast-forward) until after the future recording is complete or the future record state is canceled.

As more appliances have become available in the home and as remote control has become more popular, the issue of user control has become more complex. A remote control produces an infrared light beam to transmit a control signal when one of the remote control buttons are pushed depending on which button was pushed. The remotely controlled appliance has an infrared receiver that detects the signal and a controller that determines what action to take depending on the infrared control signal.

Many appliances come with a remote control that can only operate the specific appliance it came with. Many consumers have a large number of different appliances resulting in a large number of different remote control units required to operate these appliances. Some remote controls that come with appliances can operate more than one appliance from the same manufacturer. There are also, so called, universal remote controls that can be programmed to operate several devices that may be selected from a wide range of appliances from different manufacturers. These multi-device remote controls typically have buttons to switch them from a state to operate one appliance to a state to operate another appliance.

A more advanced universal remote control called PRONTO from PHILIPS can be programmed with macros to operate multiple appliances with the touch of one button. In PRONTO a single button can be programmed to, for example, power-on the television, set the television channel to receive input from a DVD, power-on the DVD player, and set the DVD player on play.

The integration of devices in a home environment is also becoming increasingly common. The HAVi architecture, the UPnP initiative, the Universal Serial Bus (USB), HomeRF Lite, and the Bluetooth standard, each involving substantial contributions from Philips Electronics, the Jini technology of Sun Microsystems, Inc., and others, have been developed to enhance the interoperability of multiple devices in a network.

Those skilled in the art are directed to the following references. U.S. patent application Ser. No. 09/283,545 to Yevgeniy Eugene Shteyn filed Apr. 1, 1999 describes a TiVo services network system. U.S. patent application Ser. No. 09/189,535 to Yevgeniy Eugene Shteyn filed Nov. 10, 1998 describes upgrading of synergetic aspects of home networks. U.S. Pat. No. 5537104 to Van Dort filed May 31, 1995 describes a system for equipment control, comprising a common channel.

Also, U.S. patent application Ser. No. 09/670,129 (attorney docket US 000262) filed Sep. 26, 2000 for Vladimir Pisarsky entitled “Security Monitor Of System Runs Software Simulator In Parallel”, relates to a distributed information processing system that comprises a cluster of interacting devices or appliances forming, e.g., a home network. The devices or appliances have finite state machines (FSM's) onboard for the purpose of monitoring the cluster's integrity. The system has a control server running a simulator of the cluster's FSM's.

Those skilled in the art are also directed to U.S. patent application Ser. No. 09/165,683 filed Jan. 02, 1998 and 09/213,527 filed Dec. 17, 1998 both by Yevgeniy Eugene Shteyn describing two-way control properties.

All the above identified citations are incorporated herein in whole by reference.

### SUMMARY OF THE INVENTION

In the invention herein, a home network comprises interconnected devices known as electronic consumer appliances that are state machines. The connections between appliances are wired and/or wireless, depending on the network organization, e.g. hierarchical, distributed, clustered and etc . . . , user preferences and other factors. The appliances communicate using standard and/or proprietary protocols, or a combination of thereof. At least some of the states of these appliances are controllable by control signals received through the home network. In the invention, the home network is implemented as a super state machine in which, setting the state of the home network, results in setting the state of multiple appliances on the home network according to a predefined network state definition. Advantageously, such a super state machine enables control of the network without a traditional software application running for a substantially continuous period of time.

Appliance-related information is stored in the system including a description of the available settable states of the appliances connected in the home network, and the control signals that must be sent and received through the home network to set the appliances in the respective appliance states. Also, limitations on the interactions (e.g. conflicts) between appliance states are stored in the system. The control and memory functions of the system may be centralized in a personal computer or set-top-box connected to the home network or it may be distributed among a plurality of the connected devices.

The number of appliances attached to such a network may be very large, with even larger, but theoretically finite, number of combinations of the states of the appliances connected to the home network. Although users are familiar with control of a state machine via, for example a traditional remote control, it would be difficult for a user to explore all the possible states of such a complex state machine. Therefore, in one aspect of the invention, a limited number of network states that are meaningful to the user as a whole can be directly effected in the system. The user can define the meaningful state and/or downloaded it from a third party, such as Internet service, a peer networked system and etc . . . . The user can be enabled to further customize the parameters of the downloaded meaningful state. In order to effect the networked state, the state related information may include a list of relevant appliances, control signals that need to be transmitted over the home network, signal processing instructions to be executed by a particular appliance, overall execution logic, e.g. script, user interface, and etc . . . . The aforementioned information can be stored locally or remotely.

Also, it would be difficult for a user to make sure that a particular network state would be reliable at the time at which the state is defined or at the time that setting the home network in that state is initiated. The system of the invention herein is capable of determining if a particular meaningful network state defined by a particular combination of appliance states would be reliable. The reliability of the network states can be determined at an earlier time, for example, by a computer simulation. See for example, U.S. patent application Ser. No. 09/670,129 discussed above.

A network state selection/access/review interface means can be implemented, for example, as a graphical user interface on a personal computer, PDA, mobile phone, remote control. The user is enabled to create an alternative network state by modifying the original representation. The user can access a plurality of meaningful network states that were defined earlier, and select at least one of them, thus initiating setting the home network in that state. Alternatively, the user can define a trigger state of the home network which automatically initiates setting of the home network in one of the defined states. Once setting of the home network in a particular meaningful network state is initiated, actions associated with the state, such as sending control signals to the appropriate appliances, providing feedback to the user, and etc . . . , are effected to set the appliance states according to the network state definition.

A network state definition does not have to specify the state of every device connected to the home network. If the state of a device connected to the home network is not specified by a network state definition, then when the network state is set according to the network state definition, then the state of the device that was not specified is not altered by the setting that network state. When a network state definition specifies the state of certain devices in the home network, then the states of other devices may have to be set in order to guarantee that the home network state is reliable. Reliable operation of a selected device may depend on the operation of another device in the home network. For example, when a DVD is set to play a program, then some display device must be set in a state to display the program.

In a first aspect of the invention, a meaningful network state is defined by selection from a plurality of automatically determined reliable network states. The system automatically determines the possible network states depending on which devices are attached to the home network and the device descriptions available in the home network. Then the system determines which of the possible network states would be reliable depending on the interaction limitations between devices. In response to user input, the system presents these reliable network states to the user. Then the user selects a network state that is meaningful as a whole to the user.

Preferably, the user is allowed to select a plurality of meaningful network states from among the reliable network states, and the corresponding selected meaningful network state definitions are stored in the system. Later, the user can request the system to present the meaningful network states, and if the user selects one of the meaningful network states, then the system effects them as mentioned above.

In a second aspect of the invention, a meaningful network state is defined by user selection of states of devices attached to the home network while the definition is automatically controlled so that the network state definition results in a reliable network state. In response to user input, the system presents possible states of devices connected to the home network. Then the user selects the states of the connected devices to define the meaningful network state. The system controls the defining so that the meaningful network state that is defined is reliable. The system can control the defining by controlling the presentation of possible device states, and/or by controlling the selection of displayed device states, and/or by rejecting the network state definition.

Devices that are connected to the home network may have error states, detection states, and other states that can not be set by control signals provided through the home network. Some of the devices that are connected to the home network do not have any states that can be set by control signals received from the home network, such as an open door or open window detectors. The system controls the defining so that states of devices which can not be set through the home network are not included in the meaningful network state definitions.

When the system controls the defining by controlling the display of possible device states, and the user selects a first device state, then the display is updated to remove or mark the states of other devices which would result in a network state that was not reliable in view of the users selection of the first device state. The states which can not be selected may be marked by displaying them differently from the device states that can be selected or they may be removed from the display.

When the system controls the defining by controlling the selection of displayed device states, then the system refuses to accept selections of devices which would result in a network state that was not reliable. The system may warn the user that the device state that was selected was not accepted because it may result in an unreliable state.

When the system controls the defining by rejecting network state definitions that may result in unreliable network states, then after the defining of the network state is complete, then the system checks to determine if the defined state is reliable, and if it is not reliable then the system rejects the network state definition. The system may explain to the user why the definition is not reliable, and allow the user to correct the definition.

It is possible to use various combinations of the above methods for controlling the defining of the network states to provide in a convenient manner a network state definition that results in a reliable network setting.

In a third aspect of the invention, a meaningful network state is defined according to the current state of the home network after the system automatically determines that the defined network state would result in a reliable network. In response to user input, the system determines if the current state of the home network is reliable, and if so, the current state is defined as a meaningful network state of the home network and stored in the system. Otherwise, an explanation of why the current state of the system is not reliable may be displayed to the user.

It is possible for the home network to be in an unreliable state, for example, because there may be front panel controls on the devices themselves that allow the system to be put into a state that is not reliable. For example, the user may use respective front panel controls to turn on both a radio and a separate television connected to use the same external loud speakers.

In a fourth aspect of the invention, a trigger network state is defined and associated with a resulting network state, so that, whenever the home network achieves the trigger state, the home network is automatically set in the resulting state. The trigger state is defined in a similar manner as described above for defining meaningful network states, except that any states of devices that can be determined by the system can be included in the trigger state definition even if the system can not set the devices in those states. The trigger network state may be but does not have to be, a reliable network state. The resulting state is a meaningful network state defined as described above. Both the trigger network state definition and the resulting state definition are stored in the system along with the association between the trigger network state and resulting meaningful network state. When system determines that the states of the devices that are included in the trigger state definition, match the trigger network state definition, then the trigger state is achieved and the state of the system is automatically set in the resulting meaningful network state. The system may determine if the trigger state is achieved by regularly polling the devices or the devices may transmit state signals whenever they change states.

In a fifth aspect of the invention, an original meaningful network state, that was previously defined and stored, is updated. The user selects a previously defined meaningful network state as an original network state for updating. The system displays the states of devices of the original network state definition and the possible states of devices connected to the home network, then the user selects the states of the connected devices to update the meaningful network state. The system controls the selection of states of devices for updating so that the updated state is reliable. This may be done in a manner similar to that used in defining meaningful network states by direct user selection of device states in the second aspect of the invention described above. The system can control the updating by controlling the display of possible device states, by controlling the selection of device states, and/or by rejecting the updated network state. The updated state may replace the original state definition in system storage or the updated state may be stored as an additional meaningful network state definition.

In a sixth aspect of the invention, the current state of the home network is modified by the user, and the system controls the modification process so that the modified network state is reliable. The system displays the current states of devices and the possible states of devices connected to the home network, then the user selects the states of the connected devices to modify the current network state. The system controls the modification process, so that, the modified network state is reliable. The system can control the modification, by controlling the display of possible device states, by controlling the acceptance of selections of device states, and/or by controlling the acceptance of the network state definition depending on whether the resulting network state would be reliable.

In a seventh aspect of the invention, setting the state of the home network according to a network state definition stored in the system depends on whether the resulting network state would be reliable. In response to a user input, achieving a trigger state, or a change in the home network, a state definition that is stored in the system is checked to determine if setting the home network according to the definition would result in an unreliable network state. Network state definitions are provided and stored in the home network. The system may display the stored network state definitions in response to user input. A network state is selected in response to user input. Then the system determines whether to initiate setting the home network according to the selected network definition depending on whether the resulting network state would be reliable.

A home network will often be modified as new appliances are added, replaced, or updated to provide additional functionality. A network state definition that would result in a reliable network state may be stored and then executed months or years after it was defined. Thus, the definition should be checked to determine if the definition would result in an unreliable state of the current network.

Those skilled in the art will understand the invention and additional objects and advantages of the invention by studying the description of preferred embodiments below with reference to the following drawings which illustrate the features of the appended claims:

### BRIEF DESCRIPTION OF THE DRAWINGS

FIGS. 1a and 1b illustrate a network of the invention with attached components.

FIG. 2 illustrates an example of a meaningful network state definition of the invention.

FIG. 3 illustrates an example of a trigger network state definition of the invention.

FIG. 4 illustrates the network of FIG. 1 connected to an internet server through the internet.

### DETAILED DESCRIPTION OF PREFERRED EMBODIMENTS INCLUDING BEST MODE

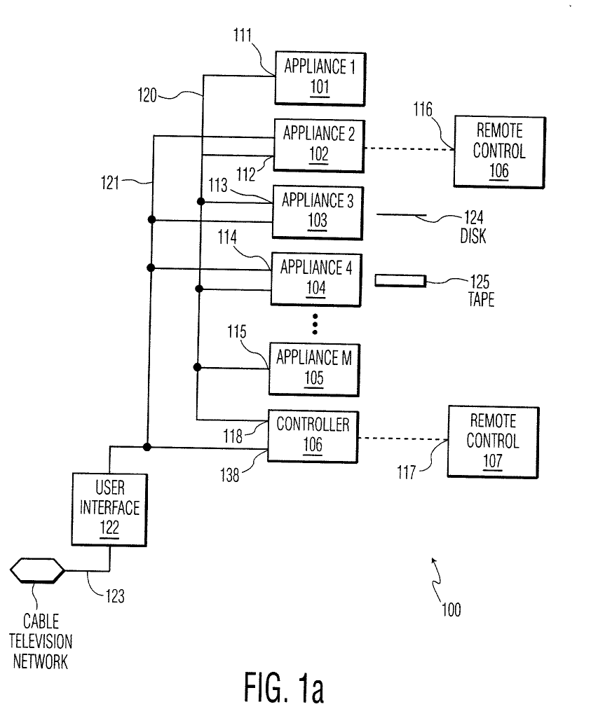

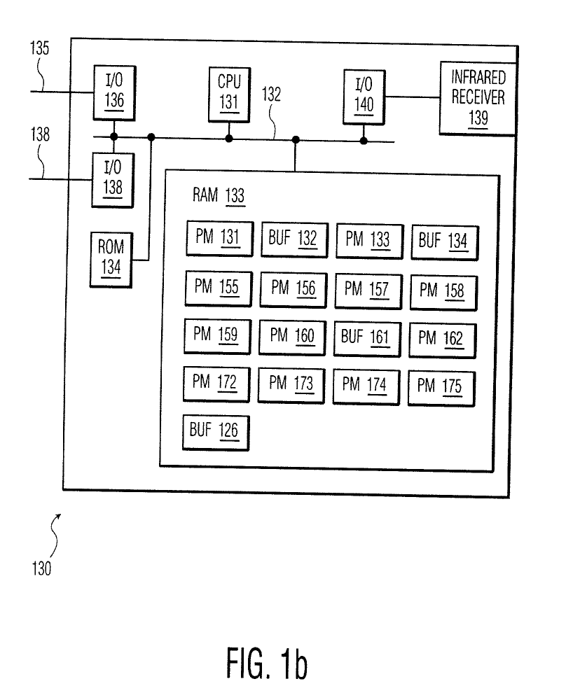

FIGS. 1a and 1b illustrate a specific example of a home network 100 of the invention. The home network includes multiple consumer electronic devices (101-108) with network connections 111-118 connected to communications network 120. Device 101 is a detection device such as a movement, smoke, temperature, or window position detector, which has one or more detectable states but does not have any settable states that can be set through the home network. In addition to the communications network 120, a broadband network 121 may also be provided for transmitting multimedia presentations between devices of the home network in cable television format. Device 105 is a simple output device with no settable states such as a constantly on loudspeaker. Each of devices 102-104 has multiple states that can be set by state control signals received at respective inputs 112-114. Device 102 is a display device which can be set on or off and can be set to display video information from various channels and has other state controls such as brightness, contrast, color corrections. Device 103 is a DVD recorder for recording and reproducing multimedia presentations on disk 124, and device 104 is a VCR for recording and reproducing multimedia presentations on tape 125. Each of devices 103-104 can be set to on or off, set on any of a large number of channels, and may also have a large number of other settable states such as record, play, pause, rewind, fast-forward, reverse, etc. as is well known in the art. Devices 102-104 may also have connections to a broadband network such as a cable television network. Display device 102 receives multimedia presentations for display through the broadband network and recorder/reproducers 103-104 receive and transmit such multimedia presentations through the broadband network.

Communications network 120 may be any known type of communications network, using for example, Ethernet, token ring or broadband methods, and using any known transmission media (e.g. electrical wires, radio waves, optical fiber, or infrared waves).

Broadband network 121 may be connected through a user interface 122 to an external cable television network 123 connected to a headend of a cable television system. This allows multimedia presentations to be quickly downloaded or uploaded to the cable television system. The user interface my be built into controller 108 or provided separately as shown. Also, there may be separate connection on the controller for the internal broadband network and the cable television system so that the channel designations of the internal broadband network are different from those of the external cable television network.

Devices 106-107 are remote control devices that are connected to the home network through respective components 102 and 108. They provide signals to the communications network, but do not receive signals from the communications network. The signals from these remote control devices are typically directed to one of the devices of the home network and may only change the state of that one device or may be received by the receiving device to another device in the home network. Device 106 is the type of remote control such as PRONTO that is specific for controlling consumer electronic devices using infrared signals. Device 107 is a computer type input device such as a infrared keyboard with an integral pointing device (joystick, trackball, touchpad).

Device 108 is a controller, such as a set-top-box, to control the state of home network 100 by providing control signals through communications network 120 to network connections 112-114 of the settable devices 102-104 to set the states of these settable devices. The controller has a CPU 131 connected to a bus 132 for communicating with random access memory (RAM) 133 (read/write memory) and read only memory (ROM) 134. The controller has a network connection 135 for communicating with the communications network through I/O processor 136. Program modules in the memory (ROM and/or RAM) control the operation of the CPU and I/O processors depending on data stored in buffers in the memory.

Program module 151 stores and retrieves information in buffer 152 indicating the settable states available for the devices attached to the home network. Program module 153 stores and retrieves information in buffer 154 indicating interaction limitations (potential conflicts) between the available settable states of different devices. For example, that only one device in the home network at a time should be set to transmit multimedia data on any one channel of the broadband network.

Program module 155 controls I/O processor 140 to receive user input through infrared receiver 139 from remote control 107, and controls I/O processor 136 to receive user input from remote control 106 through display device 102. Program module 155 communicates with the other program modules to implement user input commands and store user input information. Program module 156 displays information about the home network to the user. Module 156 controls I/O processor 136 to transmit the home network information to display 102 to present information to the user about the available states for setting the devices in the home network, the current states of devices in the home network, the stored interaction limitations between devices, and meaningful network state definitions discussed below.

Program module 157 automatically determines whether a meaningful network state definition would result in a reliable network state, the meaningful network state definition indicates respective settable states for a plurality of the devices connected to the home network for setting those devices in those device states when the home network is set in the network state according to the meaningful network state definition. “Reliability” of a network state as used herein, means both that the network state is possible and that there are no conflicts between device states. The determination of reliability depends on the states of the devices specified in the meaningful network state definition and depends on the interaction limitations stored in buffer 154 for the plurality of devices in the meaningful network state definition. The determination of reliability may also depend on the current or available states of devices which do not have their states specified in the meaningful network state definition, including device states to which the devices can not be set by network control signals and settable device states of devices that are not included in the meaningful network state definition.

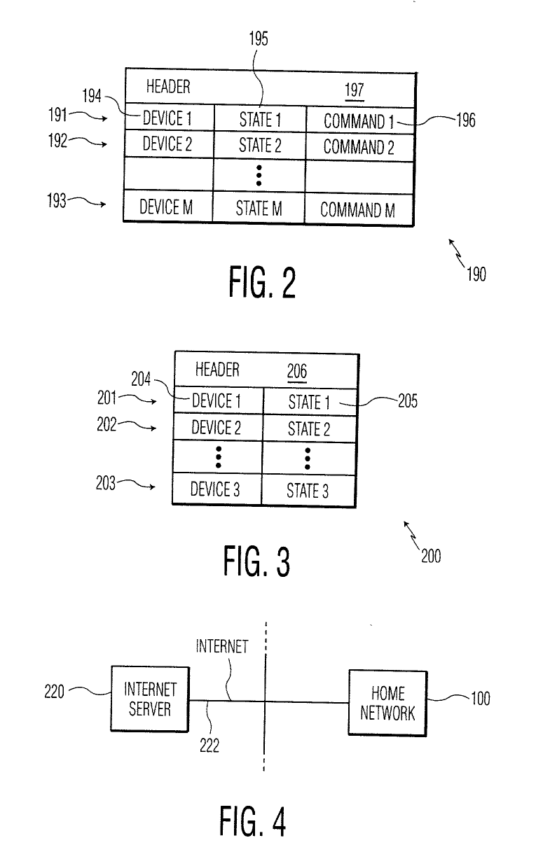

Program module 158 is used for defining network states that are meaningful as a whole to the user. Each meaningful network state definition 190 (FIG. 2) includes device state specifications for a plurality of the devices connected to the communications network that have settable states. An example of a meaningful network state definition is shown in FIG. 2 and described below.

Module 158 defines meaningful network states depending on input from the user and on the device states that are available for setting that are stored in buffer 152. Details of various processes for defining meaningful network states are described below. Program module 158 controls the defining of the meaningful network states depending on the reliability determining program module 157 so that when the network state is set according to one of the meaningful network state definitions, then the state of the home network will be reliable.

When a meaningful network state is defined by the user it may be immediately executed and/or it may be stored in the system for later execution. Program module 160 is provided to store meaningful network state definitions in memory buffer 161 for later execution.

Program module 162 provides state control signals to the communications network for setting the state of the consumer electronic devices according to the meaningful network state definition when setting the home network in the meaningful network state is initiated so as to set the state of the home network in the meaningful network state. Setting the home network in the meaningful network state may be initiated either by user input of a command or a selection to initiate setting the network state or by achieving a trigger state as described in more detail below.

Meaningful network state definitions may not have state specifications for some of the devices that have available settable states. When the home network is set in a meaningful network state, the state of any devices that have no state specified in the meaningful network state definition, are not changed regardless of the previous network state.

There are some devices whose states need to be specified in a meaningful network state definition in order to guarantee that the meaningful network state definition will result in a reliable network state when the home network is set according to only that network state definition. For example, in a meaningful network state definition, if a DVD player connected to a display is specified to play and the state of a VCR player connected to the same display is not specified, then if the VCR is playing when the setting of the network state is initiated according to the meaningful network state definition, then both the DVD and the VCR will be simultaneously sending signals to the display in the defined network state. Program module 159 may control the defining of the meaningful network state, so that, device states are specified for all devices that are required to be specified in order to guarantee that the home network will be in a reliable state when the home network is set in a state according to the meaningful network state definition. Alternatively, as discussed below, program module 160 may refuse to set the home network in a state in accordance with only a meaningful network state definition, depending on a determination by program module 157, at the time that setting the home network in the state is initiated, that the resulting network state would not be reliable.

Preferably, in order to execute one of the stored meaningful network states, in the home network system, first one of the stored meaningful network states is selected depending on user input. The home network information display program module 162 presents representations of a plurality of the meaningful network state definitions that are stored in buffer 161 to the user on display 102 in response to the user input into remote control 107. The pointer device of remote control 107 is used to move a cursor shown on display 102 onto one of the representations of the meaningful network states and the user clicks a button on the remote control to select the meaningful network state that the cursor points to. After the meaningful network state is selected for execution, program module 162 provides state control signals to the communications network to initiate setting the state of the home network in the selected meaningful network state.

Preferably the home network system provides several alternative methods for defining meaningful network states that are reliable. In one method, in response to user input, meaningful network state defining program module 158 automatically generates definitions of all the reliable network states, depending on the available settable device states stored in buffer 152 and a determination by reliability determining program module 157 using the device state interaction limitations stored in buffer 154. Then program module 158 displays representations of the definitions of the generated reliable network states to the user. The pointer device of remote control 107 is used to move the cursor shown on display 102 onto one of the representations of the reliable network state definitions and the user clicks the button on the remote control to select one of the reliable network states as a meaningful network state definition. In this way the user can define a plurality of meaningful network states. Then the selected meaningful network states are stored in buffer 161 by program module 160.

In an alternative method of defining meaningful network states, in response to user input, meaningful network state defining program module 158 displays representations of the available settable states of devices stored in buffer 152 to the user in response to user input. The pointer device of remote control 107 is used to move the cursor shown on display 102 onto one of the representations of the settable device state and the user clicks the button on the remote control to select that device state for inclusion in the meaningful network state definition. The user selects device states for a plurality of the devices connected to the communications network for inclusion in the meaningful network state definition. Definition controlling program module 159 controls the defining of the meaningful network state depending on reliability determining program module 157 using the device state interaction limitations stored in buffer 154 so that the resulting meaningful network state definition will be reliable.

The definition control program module 159 may control the defining of the meaningful network state definition program module 158 using one or more of the following methods. In a first method, the meaningful network state defining module 158 displays representations of device states only if the definition controlling program module 159 permits the display. The definition controlling module 159 in turn only permits the display of device states if the reliability determining program module 157 determines that selecting the displayed device state would result in a reliable network state depending on previous selections of device states for defining the meaningful network state and the device state interaction limitations of buffer 154.

In a second method of controlling the defining of the meaningful network states, device states that could result in an unreliable network state are displayed, but after each device state is selected, then the definition controlling program module 159 accepts or rejects the selection of a displayed device state depending on a determination of the reliability determining program module 157 whether the selection would result in a reliable network state, depending on previous selections of device states for defining the meaningful network state and the device state interaction limitations of buffer 154.

A combination of the first and second methods could be used, for example, showing the allowed device state selection with one attribute (text color, background color, italics, bold, underlined, etc.) and showing the device state selections that are not allowed with a different attribute, and then not recognizing attempts to select device states that are not allowed.

In a third method of controlling the defining of the meaningful network states, when the defining of the meaningful network state is completed, the completed definition is accepted or rejected by the definition controlling program module depending on a determination by the reliability determining program module whether the completed meaningful network state definition would result in a reliable network state depending on the stored device state interaction limitations.

The home network system of the invention further includes a program module 172 for determining the current state of the home network. In another method for defining meaningful network states, in response to user input, the meaningful network defining program module 158 derives a meaningful network state definition depending on the current network state information provided by the current state determining program module. In addition, the defining is controlled by program module 159 depending on a determination by the reliability determining program module 157 that the current state of the home network is reliable. The user selects the devices that will be included in the meaningful network state and the specification of the states of those devices in the meaningful network state definition are the current states of those devices.

In a different aspect of the invention, the user may define a trigger network state and associate the trigger network state definition with a resulting state definition which is a meaningful network state definition. The trigger network state definition and the designation of the resulting network state are stored in the system. When the current network state matches the trigger network state definition then the trigger state is achieved and the home network system will automatically initiate setting the home network in the resulting state depending on the resulting state definition. The home network system includes program module 173 for defining a trigger network state depending on user input. The method of defining a trigger state is discussed in more detail below. The home network further includes program module 174 for designating a meaningful reliable network state as a resulting state to be automatically set when the trigger state is achieved.

In order to select a meaningful network state, in the home network system, as the resulting state, any of the methods described above may be used to define a new meaningful network state definition. Alternatively, one of the existing meaningful network state definitions stored in buffer 161 may be used. In that case, the home network information display program module 156 presents representations of a plurality of the meaningful network state definitions that are stored in buffer 161 to the user on display 102 in response to the user input into remote control 107. The pointer device of remote control 107 is used to move the cursor shown on display 102 onto one of the representations of the meaningful network states and the user clicks the button on the remote control to select the meaningful network state that the cursor points to. Program module 175 stores the trigger state and the designation of the meaningful network state as a resulting state in buffer 176.

Program module 172 determines the current state of the home network, and program module 177 determines whether any of the defined trigger states are achieved depending on the determination of the current state and the trigger network state definition stored in buffer 176. When one of the trigger states are achieved, program module 162 provides state control signals to the communications network to initiate the resulting state that is associated with the achieved trigger state.

The process for defining the trigger network state may include one or more of the following specific examples, and preferably, the user selects a method from one of the following processes. In a first process for defining a trigger state, the trigger state defining program module automatically generates definitions for all the reliable states of the home network, depending on the available settable device states stored in buffer 152 and a determination by reliability determining program module 157 using the device state interaction limitations stored in buffer 154. Then program module 158 displays representations of the definitions of the generated reliable network states to the user. The pointer device of remote control 107 is used to move the cursor shown on display 102 onto one of the representations of the reliable network state definitions and the user clicks the button to select the reliable network state definition.

In a second alternative process for defining a trigger state, in response to user input, trigger state defining program module 173 displays representations of all the detectable states of all the devices with detectable states that are connected to the communications network. Preferably, all the detectable states of all the devices connected to the communications network are stored in buffer 152 along with the available settable states of the devices with settable states. The pointer device of remote control 107 is used to move the cursor shown on display 102 onto one of the representations of a detectable device state and the user clicks one of the buttons on the remote control to select that device state for inclusion in the trigger network state definition. The user selects detectable device states for a plurality of the devices connected to the communications network for inclusion in the trigger network state definition.

In a preferred embodiment, the meaningful network state defining program module 158 can be used to update a previously stored meaningful network state definition so that the updated network state is meaningful as a whole to the user, depending on user input. The user can select for updating, the last meaningful network state into which the home network was set or one of the meaningful network states that are stored in buffer 161. An example method for selecting one of the stored meaningful network states is described above in relation to executing one of the stored meaningful network states. In a method of updating the selected meaningful network state, program module 158 initiates information display program module 156 to display representations of the device states of the selected meaningful network state on display 102 and additional and alternative device states that the settable devices can be set to that are stored in buffer 152. The user moves the cursor on the display onto one of the representations of the additional or alternative settable device states and the user clicks the button on the remote control to select that alternative device state for updating the meaningful network state definition to set the respective device in the selected device state. The user may selects additional or alternative device states for a plurality of the devices connected to the communications network for inclusion in the updated meaningful network state definition.

Definition controlling program module 159 controls of the updating of the meaningful network state depending on reliability determining program module 157 using the device state interaction limitations stored in buffer 154 so that the resulting updated meaningful network state definition will be reliable. Any of the above identified methods of controlling the defining of the meaningful network states can be used for controlling the updating of the meaningful network states with obvious alterations as required. Then, in response to user input, program module 160 stores the updated meaningful network state in buffer 161 either as a new meaningful network state or as a replacement for the selected meaningful network state.

The home network system of the invention allows the current state of the home network to be modified so that the resulting state of the home network is reliable. In a method of modifying the current network state, program module 172 determines the current state of the home network and program module 156 displays representations of the current state of the devices of the home network on display 102 and alternative device states that the devices can be set to derived from information in buffer 152. The user moves the cursor on the display onto one of the representations of the alternative settable device states and the user clicks the button on the remote control to select that alternative device state for modifying the current network state. The user may selects alternative device states for a plurality of the devices connected to the communications network for modifying the current network state. Definition controlling program module 159 controls of the modification of the current network state depending on reliability determining program module 157 using the device state interaction limitations stored in buffer 154 so that the resulting modified network state will be reliable. Any of the above identified methods of controlling the defining of the meaningful network states can be used for controlling the modification of the current network state with obvious alterations as required. Then program module 162 provides state control signals to the communications network for changing the setting of the state of the consumer electronic devices of the home network depending on user input.

In this example embodiment of the invention, the defining and updating of stored meaningful network states are controlled so that the network state that is set according to one of the stored meaningful network state definitions will be a reliable network state. However, the home network of the embodiment may be updated by adding devices to the home network, removing devices from the home network, or adding additional functionality to existing devices in the home network. Furthermore a user may be able to control the state of a device connected to the communications network so that setting the home network according to a meaningful network definition could result in an unreliable state. For example, if the VCR is unplugged from electrical power then a meaningful network state definition where the VCR is set to record is unreliable even though it was previously determined to be a reliable definition.

Thus, in order to guarantee that initiating the setting of the home network according to one of the stored meaningful network state definitions will result in a reliable network state, the reliability of the meaningful network state definition has to be verified prior to use. Thus, in this example embodiment, when program module 162 is executed to initiate setting the home network in a state according to a stored meaningful network state definition, module 162 accesses program module 157 to determine if the stored meaningful network state definition would result in a reliable network state depending on the current state of the home network and the device state interaction limitations. If the meaningful network state definition would result in a reliable network state then control signals are provided through the communications network to the devices with device states specified in the meaningful network state definition to set the home network in the defined meaningful network state. Otherwise, if the meaningful network state definition would not result in a reliable network state then an error message is displayed to the user by program module 156 on display 102, and setting the home network according to the meaningful network definition is not initiated.

The structure of an embodiment of a meaningful network state definition 190 is shown in FIG. 2. In this example, the meaningful network state definition consists of a table in which each row 191-193 includes an indication of a device 194 to be set when setting the network state is initiated and an indication of the state 195 that the device is to be set to. The device indication 194 may be an identifier of the device such as a device name or device identification number or may be the pointer to a device indicator stored elsewhere in the memory. Similarly, the device state indication 195 may be an identifier of the device state such as a device state name or device state identification number or may be the pointer to a device state identifier. The row may also include command 196 (or command identifier) to be transmitted over the communications network of the home network system when the meaningful network state is initiated in order to change the state of the device that is indicated in the row. The meaningful network state definition may further contain other information such as a header 197 with an identifier for the meaningful network state definition or the rows may include alternative device states (not shown) that may depend, for example, on the current state of the device identified in the row or even on the current state of another device in the home network (e.g. if its night turn the lights on otherwise leave them off).

FIG. 3 illustrates an example structure of a trigger network state definition 200. The trigger network state definition may essentially consist of the first two columns of the above described meaningful network state definition. That is, each row 201-203 contains a device indication 204 and a device state indication 205. The trigger network state definition may also include a header 206 containing a trigger state identifier and resulting state indication such as the name, identification number, or a pointer to a meaningful network state definition. When the current state of the home network matches the trigger network state definition, then the system initiates setting the home network according to the resulting state which is a meaningful network state stored in the system. Alternatively, an additional structure (not shown) may be provided that relates each trigger state to one of the resulting states.

FIG. 4 illustrates the home network 100 of FIG. 1 connected with an internet server 220 through the internet 222. The internet server contains portions of controller 130 of FIG. 2 that may be shared by multiple home networks. For example, program modules 157 and 158 may be incorporated in the internet server and access through the internet buffers 152 and 154 contained in the home network. Then meaningful network state defining program module 158 may automatically generate definitions of all the reliable network states, depending on the available settable device states stored in buffer 152 and reliability determining program module 157 can determine the reliable states by accessing through the internet the device state interaction limitations stored in buffer 154. Then program module 158 can display representations of the definitions of the generated reliable network states to the user through the internet.

The invention has been disclosed with reference to specific preferred embodiments, to enable those skilled in the art to make and use the invention, and to describe the best mode contemplated for carrying out the invention. Those skilled in the art may modify or add to these embodiments or provide other embodiments without departing from the spirit of the invention. Thus, the scope of the invention is only limited by the following claims:

We claim:

1. Apparatus (100) for defining states of a home network, comprising:
multiple consumer electronic devices (102-104) each having multiple states that are settable by state control signals received by the device at a respective network connection (112-114) of the device;
a communications network (120) communicating with the network connections of the consumer electronic devices to provide the state control signals to the devices through the communications network;
device state storing means (151,152) for storing the settable states of each device;
limitation storing means (153, 154) for storing interaction limitations between states of different devices;
user input means (106-107, 139-140, 155) for receiving user input;
display means (102, 156) for displaying network information to the user;
reliability determining means (157) for automatically determining whether a network state definition (190) would result in a reliable network state, the network state definition indicating respective settable states for a plurality of the devices connected to the communications network for setting those devices in those device states when the home network is set according to the network state, reliability including that the network state is possible and without device conflicts, the determination depending on the states of the devices in the network state definition and depending on the stored device state interaction limitations for the plurality of devices in the network state definition;
meaningful network state defining means (158) for defining a network state that is meaningful as a whole to the user, depending on the user input and on the stored available device states;
definition controlling means (159) for controlling the defining of the meaningful network state depending on the reliability determining means 157 so that the defined meaningful network state would result in a reliable network state; and
means (162) for providing state control signals through the communications network for setting the state of the consumer electronic devices according to the meaningful network state definition (190) when setting the home network in the meaningful network state is initiated so as to set the state of the home network in the meaningful network state.

2. The network state defining apparatus of claim 1 in which:
the meaningful network state definition includes state specifications for a plurality of the devices connected to the communications network that have settable states and no state specified for another device that has settable states so that when the home network is set in the meaningful network state definition, the state of the device that has no specified state in the meaningful network state definition, is not changed regardless of the previous network state;
setting the home network in the meaningful network state is initiated by either user input or by achieving a trigger state;
when a state of a first device is included in the meaningful network state definition, then a state of a second devices is automatically included in the meaningful network state definition in order to assure that the meaningful network state is reliable;
the network connections of one or more of the consumer electronic devices include connectors for electrically conductive wires and the means for transmitting state control signals include electrically conductive wires connected to the network connections of the devices;
the network connections of one or more of the consumer electronic devices include infrared receivers and the means for transmitting state control signals include an infrared transmitter;
the network state definitions each include a list of device indications to identify devices to which state setting signals are transmitted and indications of the respective state setting signals that are transmitted to each device so as to establish the defined meaningful network state.

3. The network state defining apparatus of claim 1 in which:
the apparatus further comprises means (160, 161) for storing a plurality of meaningful network state definitions;
the displaying means presents representations of the plurality of meaningful network state definitions to the user in response to the user input; and
the state control signal providing means provides signals through the communications network to initiate setting the state of the home network in a meaningful network state in response to user input of a selection of one of the displayed representations of meaningful network state definitions.

4. The network state defining apparatus of claim 3 in which the apparatus include a set-top-box (108) communicating with a display (102) for presenting the definitions of a plurality of the meaningful network states on a display device and an infrared receiver (139) for receiving user input of a selection of the meaningful network state from a remote control device (117).

5. The network state defining apparatus of claim 1 in which the meaningful network state defining means automatically generate definitions of a plurality of reliable network states, depending on the settable device states and the device state interaction limitations stored in the system; and display the definitions of the reliable network states to the user in response to user input; and define the meaningful network state depending on user input of a selection of one of the displayed reliable network state definitions.

6. The network state defining apparatus of claim 5 in which:
all the possible reliable state definitions are determined and user input controls the presentation of the possible reliable state definitions to the user;
the user is permitted to select multiple reliable state definitions for defining multiple corresponding meaningful network states; and
the apparatus further comprises means (160, 161) for storing network state definitions that are meaningful and reliable, in which the selected meaningful network definitions are stored.

7. The network state defining apparatus of claim 1, in which:
the meaningful network state defining means displays representations of the stored settable states of devices to the user in response to user input and the user selects a representation of one of the settable states for each device that has a specified state in the meaningful network state definition; and
the controlling of the defining of the meaningful network state is selected from one or more of:
displaying representations of device states, depending on a determination of the reliability determining means that a device state would result in a reliable network state which depends on previous selections of device states for defining the meaningful network state and the device state interaction limitations;
accepting the selection of displayed device states, depending on a determination of the reliability determining means that a selection would result in a reliable network state, depending on previous selections of device states for defining the meaningful network state and the device state interaction limitations;
accepting the completed meaningful network state definition, depending on a determination of the reliability determining means, that the definition would result in a network state that is reliable.

8. The meaningful network state defining apparatus of claim 1 in which the meaningful network state defining means:
displays representations of the stored settable states of devices connected to the communications network to the user in response to user input; and
defines a meaningful network state depending on user input of selections of the settable states of a plurality of the devices and depending on a determination of the reliability determining means that the current state definition would result in a reliable network state which depends on the stored device state interaction limitations so that the meaningful network state that is defined is reliable.

9. The meaningful network state defining apparatus of claim 1, in which:
the apparatus further comprises means (172) to determine the current network state and the meaningful network state defining means derive a current network state definition in accordance with the current state of the home network in response to user input;
the reliability determining means determines whether the current network state definition would result in a reliable network state; and
the meaningful network state defining means defines the current state of the home network as a meaningful network state depending on a determination of the reliability determining means that the current state definition would result in a reliable network state.

10. The meaningful network state defining apparatus of claim 1, in which the apparatus further comprises:
trigger state defining means (173) for defining a trigger network state depending on user input, the trigger network state defining being selected from one or more of:
displaying a plurality of reliable network states and selecting one of the reliable network states as a trigger state;
displaying representations of the stored settable states of devices connected to the communications network to the user in response to user input; and defining a trigger network state depending on user input of selections of the settable states of a plurality of the devices; and
determining the current network state and defining the current states of a plurality of devices of the current network state as a trigger state;
the apparatus further comprising:
means (174) for designating a meaningful reliable network state as a resulting state to be automatically set when the trigger state is achieved;
means (175,176)) for storing in the home network, the trigger state and the designation of the resulting network state for the trigger state;
means (172) for determining the current state of the home network; and
means (177) for determining when the trigger state is achieved depending on the current state and for initiating the setting of the home network in the resulting network state according to the stored association.

11. The meaningful network state defining apparatus of claim 1 in which:
the apparatus further comprises means (160, 161) for storing meaningful network state definitions; and
the meaningful state defining means updates a previously stored meaningful network state definition so that the updated network state is meaningful as a whole to the user, depending on user input, the meaningful network state updating includes displaying representations of the stored settable states of devices connected to the communications network to the user in response to user input, and defining an updated meaningful network state depending on user input of selections of the settable states of a plurality of the devices, the updating depending on a determination of the reliability determining means that the updated network state definition would result in a reliable network state.

12. The meaningful network state defining apparatus of claim 11 in which the updated meaningful network state is stored as a meaningful network state by the meaningful network state definition storing means.

13. Apparatus (100) for modifying the state of a network, comprising:
multiple consumer electronic devices (102-104) each having multiple states that are settable by state control signals received by the device at a respective network connection (112-114) of the device;
a communications network (120) communicating with the network connections of the consumer electronic devices to provide the state control signals to the devices through the communications network;
device state storing means (151,152) for storing the settable states of each device;
limitation storing means (153, 154) for storing interaction limitations between the device states;
user input means (106-107, 139-140, 155) for receiving user input;
display means (102, 156) for displaying network information to the user;
means (162) for determining the current state of the home network;
reliability determining means (157) for automatically determining whether a change in the state of a selected device in the home network would result in a reliable network state, reliability including that the home network state is possible and without device conflicts, the determination depending on the current states of the devices in the home network and depending on the stored device state interaction limitations for the plurality of devices in the network state definition;
means (158) for providing state control signals through the communications network for changing the setting of the state of the consumer electronic devices depending on user input and depending on an automatic determination of the reliability determining means that the resulting network state would be reliable which depends on the device states in the network state definition and the device state interaction limitations.

14. Apparatus for setting a network in a predetermined state, comprising:
multiple consumer electronic devices (102-104) each having multiple states that are settable by state control signals received by the device at a respective network connection (112-114) of the device;
a communications network (120) communicating with the network connections of the consumer electronic devices to provide the state control signals to the devices through the communications network;
device state storing means (151,152) for storing the settable states of each device;
limitation storing means (153, 154) for storing interaction limitations between the device states;
means (158) for providing a network state definition to the apparatus, the network state definition including settable states for a plurality of the devices connected to the communications network for setting those devices in those device states when the home network is set in a network state based on the network state definition;
means (160, 161) for storing the network state definition;
reliability determining means (157) for automatically determining whether the network state definition would result in a reliable network state, reliability including that the network state is possible and without device conflicts, the determination depending on the states of the devices in the network state definition and depending on the stored device state interaction limitations for the plurality of devices in the network state definition;
means (162) for providing state control signals through the communications network for setting the state of the consumer electronic devices according to the network state definition when setting the home network in the meaningful network state is initiated and depending on an automatic determination of the reliability determining means that the network state definition would result in a reliable network state which depends on the device states in the network state definition and the device state interaction limitations so as to set the state of the home network in the defined network state.

15. Apparatus for programming a programmable network state controller for use in the network of claim 1, comprising:
programming means for providing device state storing apparatus (151,152) for storing the settable states of devices in a home network;
programming means for providing limitation storing apparatus (153, 154) for storing interaction limitations between states of different devices in the home network;
programming means for providing user input apparatus (155) for receiving user input;
programming means for providing display apparatus (156) for displaying network information to the user;
programming means for providing reliability determining apparatus (157) for automatically determining whether a network state definition (190) would result in a reliable network state, the network state definition indicating respective settable states for a plurality of the devices connected to the communications network for setting those devices in those device states when the home network is set according to the network state, reliability including that the network state is possible and without device conflicts, the determination depending on the states of the devices in the network state definition and depending on the stored device state interaction limitations for the plurality of devices in the network state definition;
programming means for providing meaningful network state defining apparatus (158) for defining a network state that is meaningful as a whole to the user, depending on the user input and on the stored available device states;
programming means for providing definition controlling apparatus (159) for controlling the defining of the meaningful network state depending on the reliability determining apparatus (157) so that the defined meaningful network state would result in a reliable network state; and
programming means for providing apparatus (162) for providing state control signals through the communications network for setting the state of the consumer electronic devices according to the meaningful network state definition (190) when setting the home network in the meaningful network state is initiated so as to set the state of the home network in the meaningful network state.

16. The apparatus of claim 15 selected from one or more of: programmed computer media for use in a media drive of the controller, programmed computer memory for connection to the controller, a programmed computer for connection to the controller, optically readable media that can be read by an optical reader of the controller.

17. A control system for enabling a user to control a home network, the network including a plurality of interconnected devices that are each controllable as a state machine, comprising:
means for communicating with the user;
means to communicate with the devices through the network; and
means to control the network as a super state machine that includes the state machines of a plurality of the devices.

18. Signals for programming a home network for enabling a user to control a home network, the network including a plurality of interconnected devices that are each controllable as a state machine, comprising:
means for programming to network for communicating with the user;
means for programming the network for communication with the devices through the network; and
means to control the network as a super state machine that includes the state machines of a plurality of the devices.

19. The signals of claim 18 wherein the signals are stored on computer media for programming a home network using a computer media reader.

20. A method of doing business, comprising:
offering to determine reliable network states for a home network controlled as a super state machine that includes state machines for a plurality of devices connected in the home network; and
programming an internet server with means to: communicate with a home network; determine what controllable devices are connected to a home network; determine a reliable network state that may be meaningful to the user of the home network; generate a control script to control the home network in the reliable network state; and provide the control script to the user of the home network.

21. The method of doing business of claim 20 in which the internet server generates a plurality of reliable network states; presents representations of the reliable network states to the user; and provide the user with a control script depending on a selection of one of the reliable network states by the user.
